(19) United States
(12) Patent Application Publication
(10) Pub. No.: US 2006/0042103 A1
(43) Pub. Date: Mar. 2, 2006

(54) Electric shaver and cleaning system therefor

(75) Inventor: James E. Chasen, West Haven, CT (US)

Correspondence Address: SENNIGER POWERS, ONE METROPOLITAN SQUARE, 16TH FLOOR, ST LOUIS, MO, 63102, US

(73) Assignee: Rovcal, Inc., Madison, WI (US)

(21) Appl. No.: 11/176,488

(22) Filed: Jul. 7, 2005

Related U.S. Application Data
(60) Provisional application No. 60/606,384, filed on Aug. 31, 2004.

(51) Int. Cl. B26B 21/40

(52) U.S. Cl. 30/537

(57) ABSTRACT

In a cleaning system for cleaning hair clippings from the interior space of an electric shaver, the shaver has at least one inlet port other than the openings through which hair is received in the interior space of the shaver. A housing of the cleaning system has a shaver support for supporting the electric shaver during operation of the cleaning system. A gas delivery assembly of the cleaning system has at least one nozzle assembly configured and arranged for directing cleaning gas directly into the at least one inlet port of the electric shaver for delivery of the pressurized gas into the interior space of the shaver. In at least one embodiment, a pressure vessel supported by the cleaning system housing contains pressurized cleaning gas and supplies the gas to the at least one nozzle assembly for delivery into the interior space of the shaver.

### CROSS-REFERENCE

This application claims priority to U.S. Provisional Patent Application Ser. No. 60/606,384 filed Aug. 31, 2004.

### FIELD OF INVENTION

This invention relates generally to electric dry shavers, and more particularly to automated cleaning systems for such shavers.

### BACKGROUND

Over the last several years, both men and women have been increasingly drawn to the advantages provided by electric dry shavers. In general, the use of razors or other wet shaving systems is inconvenient for removing or shaving long hair and/or short hair or stubble, as commonly found in men's beards and women's legs. In addition, with the ever increasing time constraints and commitments individuals typically encounter, a fast and effective shaving system is most desirable.

The discomfort as well as the time consumed in using shaving creams, soaps and gels associated with using a razor type shaver requires more time and inconvenience than many individuals are willing to or are capable of experiencing. The cost of maintaining a sufficient supply of these products can create an additional burden. Consequently, electric dry shavers, which are operable from an electrical outlet or may be battery powered, have gained in popularity.

Two of the more common electric dry shaver constructions are typically referred to as foil type shavers (or foil shavers) and rotary type shavers (or rotary shavers). In a foil shaver, a reciprocating cutting blade cooperates with a thin, flexible mesh screen or apertured foil, while a rotary shaver employs one or more (typically three) circular-shaped cutting blades, each cooperating with a respective circular-shaped mesh screen or apertured foil (commonly referred to as a shaving head).

In operation, the cutting blades are rapidly and continuously reciprocally or rotationally moved past one side of the mesh screen or apertured foil, causing the cutting blades to repeatedly cross the plurality of openings formed in the screen or foil and provide a virtually continuous cutting action at each aperture. By slidingly guiding the other side of the mesh screen or apertured foil over the skin surface to be shaved, individual hair shafts enter the openings formed in the screen or foil and are cut by the reciprocating or rotating cutting blades. The cut hairs are typically collected in the interior of the shaver.

One inconvenience associated with both foil and rotary type electric dry shavers is the necessity to intermittently clean debris (i.e., hair clippings) from the interior of the shaver. This typically requires opening the shaver, often by separating the mesh screens or foils (along with any mounting or support structure therefore) from the shaver, to gain access to the interior space. To eliminate the need for individuals to manually open and clean out the interior of the shaver, prior art systems have been developed which provide an automated cleaning system.

There is a need, therefore, for a cleaning system for cleaning an electric dry shaver without having to open the shaver.

### SUMMARY

A cleaning system according to one embodiment of the present invention for cleaning hair clippings from an electric shaver generally comprises a housing having a shaver support for supporting the electric shaver during operation of the cleaning system. A gas delivery assembly comprising at least one nozzle assembly is configured and arranged for directing cleaning gas into the interior space of the electric shaver.

In one embodiment of a combination electric shaver and cleaning system for cleaning hair clippings from the electric shaver, the electric shaver generally comprises an outer cutting member for contact with a user's skin and having openings therein for receiving hairs therethrough. The outer cutting member at least in part defines an interior space of the shaver in which hair clippings accumulate. An inner cutting member is disposed within the interior space of the shaver and is moveable relative to the outer cutting member to cut hairs received through the outer cutting member. The shaver has at least one inlet port other than the openings in the outer cutting member and in fluid communication with the interior space of the shaver for receiving cleaning gas into the interior space of the shaver. The cleaning system of the combination generally comprises a housing having a shaver support for supporting the electric shaver during operation of the cleaning system. A gas delivery assembly comprises at least one nozzle assembly configured and arranged for directing cleaning gas directly into the at least one inlet port of the electric shaver for delivery of the cleaning gas into the interior space of the shaver.

In one embodiment of a method of the present invention for cleaning hair clippings from an electric shaver, a pressure vessel is charged with pressurized cleaning gas. The cleaning gas is subsequently released from the pressure vessel and delivered into the interior space of the shaver other than through openings formed in an outer cutting member of the shaver. Hair clippings in the interior space become entrained in the flow of cleaning gas and are exhausted from the interior space of the shaver along with the cleaning gas through the openings in the outer cutting member of the shaver.

### BRIEF DESCRIPTION OF THE DRAWINGS

FIG. 1 is a perspective view of one embodiment of a cleaning system of the present invention for cleaning an electric shaver, with an electric shaver of the present invention inserted in the cleaning system;

FIG. 2 is a perspective view of the cleaning system of FIG. 1 with the electric shaver removed from the cleaning system;

FIG. 3A is a side elevation of the cleaning system and shaver of FIG. 1 with a panel member of the cleaning system housing removed to reveal internal components of the cleaning system;

FIG. 3B is a side elevation of the opposite side of the cleaning system and shaver of FIG. 1 with the opposite panel member removed to reveal internal components of the cleaning system;

FIG. 4 is an exploded perspective of the cleaning system of FIG. 2;

FIG. 5 is a perspective view of an electric rotary shaver according to one embodiment of the present invention for use with the cleaning system of FIG. 1;

FIG. 6A is an exploded perspective view of a shaver support of the cleaning system of FIG. 1;

FIG. 6B is another exploded perspective view of the shaver support, and a filter assembly of the cleaning system of FIG. 1;

FIG. 7 is a perspective view of a second embodiment of a cleaning system of the present invention, and an electric foil shaver according to a second embodiment of the present invention;

FIG. 8 is a perspective view of the electric foil shaver of FIG. 7 removed from the cleaning system; and

FIG. 9 is a side elevation of a third embodiment of a cleaning system of the present invention, with a side panel of the cleaning system housing removed to reveal internal components of the cleaning system.

Corresponding reference characters indicate corresponding parts throughout the drawings.

### DETAILED DESCRIPTION

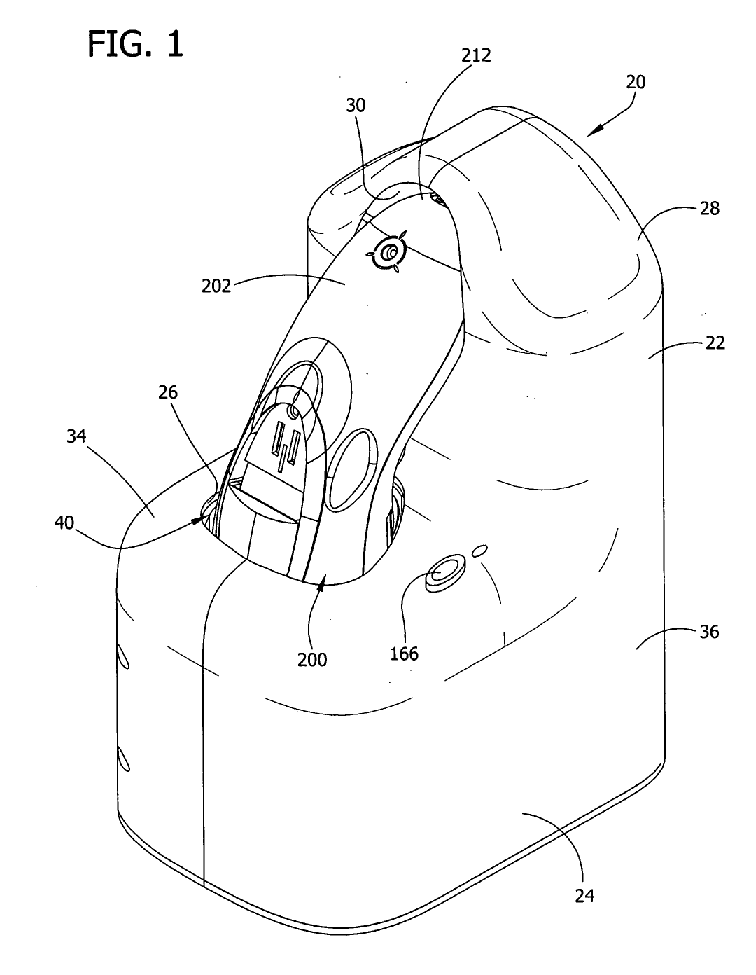

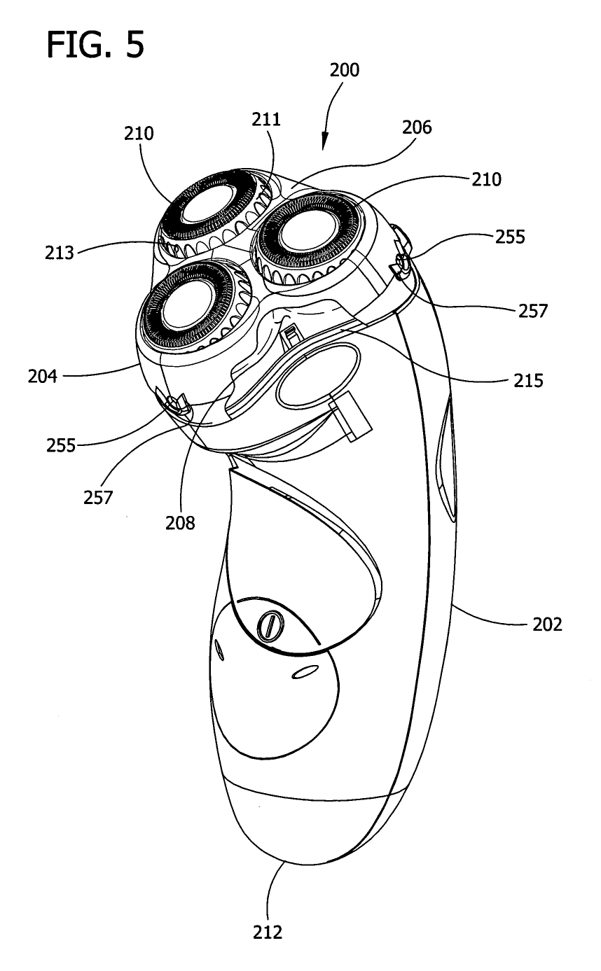

With reference now to the drawings and in particular to FIG. 1, one embodiment of a cleaning system of the present invention for cleaning an electric dry shaver is generally designated 20 and is illustrated as being constructed for use in cleaning an electric rotary shaver 200 constructed in accordance with one embodiment of a shaver of the present invention. As seen best in FIG. 5, the rotary shaver 200 generally comprises a handle portion 202 housing various operating components of the shaver such as a motor (not shown) and suitable drive gear (not shown) and a cutting assembly, generally indicated at 204, releasably connected to the handle portion 202. The cutting assembly 204 of the illustrated rotary shaver 200 particularly comprises a support frame 206 that is releasably connected to the handle portion 202 of the shaver and together with the handle defines an interior hair pocket 208 (broadly an interior space of the shaver) in which hair clippings are collected during shaving.

Shaving heads 210 (broadly, outer cutting members of the shaver) in the form of circular or cup-shaped foils having openings therein are set within and extend outward of the support frame 206 for contact of the outer surfaces of the shaving heads with the user's skin during shaving. The shaving heads 210 also in part define the hair pocket 208. A guard ring 211 encircles the annular sidewall of each shaving head 210 is contact therewith. Suitable cutting blades (not shown) (broadly, inner cutting members of the shaver) are disposed within the hair pocket in abutting but slidable relationship with the interior surfaces (sometimes also referred to as the track surfaces) of the respective shaving heads 210. The cutting blades are drivingly connected to the shaver motor via the drive gear for being rotatably driven relative to the shaving heads 210.

In operation of the shaver 200, as the outer surfaces of the shaving heads 210 are moved by the user over the surface of the skin, hairs (e.g., whiskers) enter openings in the shaving heads and extend into the hair pocket 208. As the cutting blades rotate relative to the inner surfaces of the shaving heads 210, the shearing action between the cutting blades and the edges of the shaving heads at the openings thereof shears the hairs that extend through the openings in the shaving heads. The hair clippings then accumulate within the hair pocket 208. The construction and operation of the rotary shaver 200 as described heretofore is known to those skilled in the art and need not be described further except to the extent necessary to set forth the present invention.

For purposes of describing the present invention, the shaving heads 210 are referred to herein as being at a downstream end of the shaver 200 and the distal end 212 of the handle portion 202 (i.e., opposite the end at which the shaving heads are located) is referred to herein as being at an upstream end of the shaver. Accordingly, the cutting blades and hair pocket 208 of the shaver 200 are considered herein to be upstream of the shaving heads 210 and the handle portion 202 is upstream of the cutting blades.

In the illustrated embodiment of FIG. 5, each guard ring 211 surrounding a respective shaving head 210 has indentations 213 formed in the outer surface of the guard ring 211 in closely spaced relationship with each other about the circumference thereof to provide space between the guard ring and the support frame 206 through which air and hair clippings can exit the shaver as described later herein.

The rotary shaver 200 illustrated in FIG. 5 also further comprises three inlet ports 255 (two are visible in FIG. 5) extending transversely inward through the side of the support frame 206 of the cutting assembly 204 for fluid communication with the hair pocket 208 of the shaver. In the illustrated embodiment, the inlet ports 255 are suitably disposed upstream of the cutting blades. However, it is contemplated that the inlet ports 255 may be disposed downstream of the cutting blades, and may even be disposed in and extend longitudinally through the end face of the support frame 206, as long as the inlet ports are in fluid communication with the hair pocket 208. It is alternatively contemplated that the inlet ports 255 may be disposed in the handle portion 202 of the shaver 200 without departing from the scope of this invention, as long as the inlet ports are in fluid communication with the hair pocket 208. A raised guide member 257 projects out from the side of the cutting assembly support frame 206 and handle portion 202 of the shaver 200 and partially surrounds each inlet port 255 for purposes which will become apparent.

A sealing member 215, is disposed in the handle portion (although it may instead be in the cutting assembly, about the breakline along which the cutting assembly separates from the handle portion of the shaver. Accordingly, the hair pocket 206 of the shaver is substantially sealed other than at the inlet ports 255, the shaving heads 210 and indentations 213 in the guard rings 211.

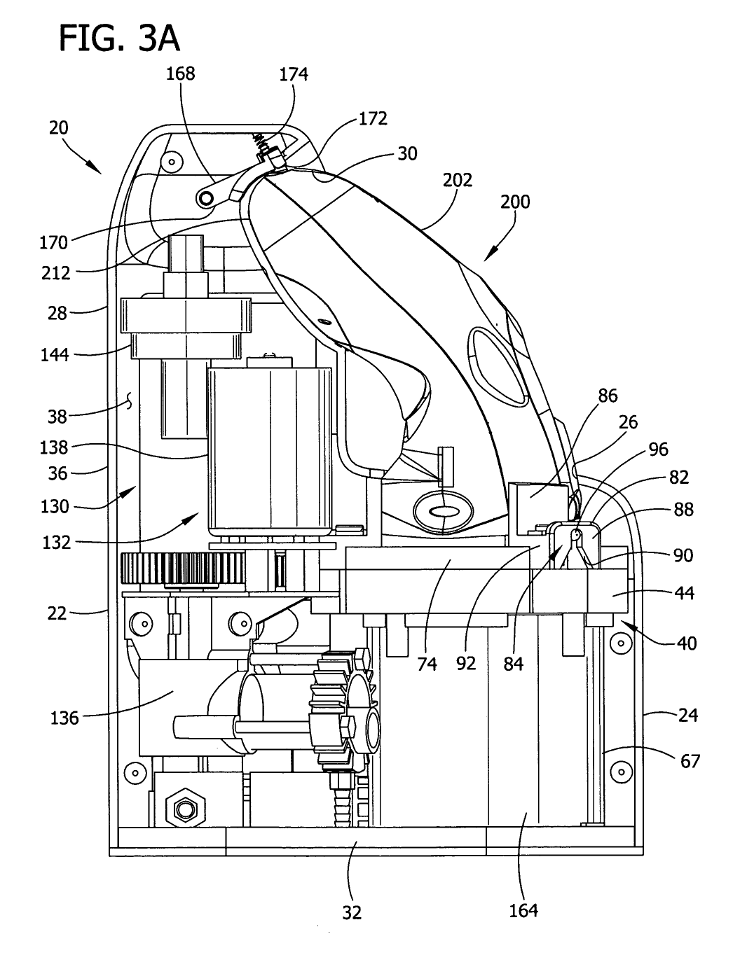

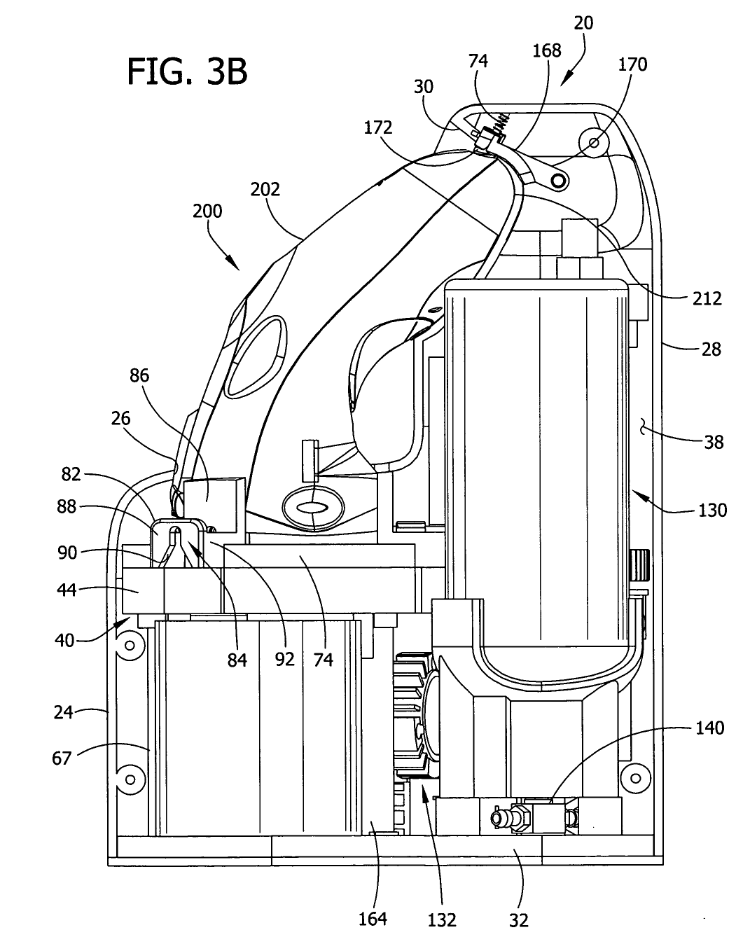

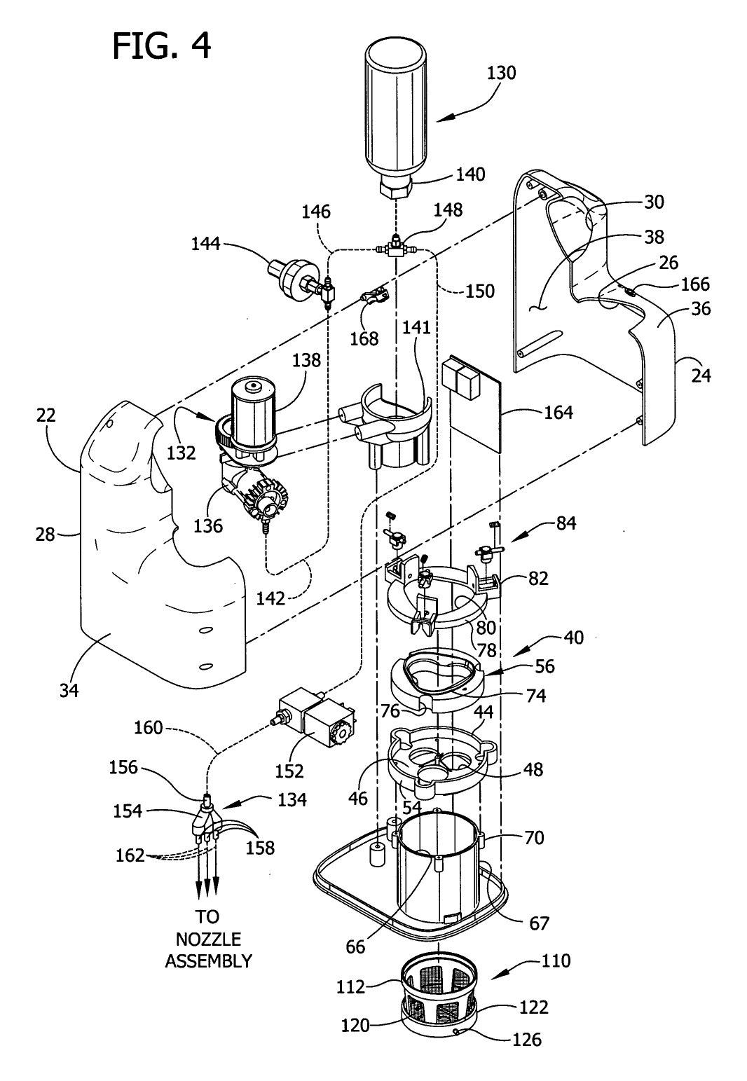

Referring again to FIG. 1, the cleaning system 20 comprises a housing, generally indicated at 22, for housing various components of the system. The housing 22 illustrated in FIG. 1 is configured to generally define a base portion 24 having an opening 26 in the upper surface thereof to receive the shaver into the base portion for cleaning, and an upstanding portion 28 extending up from the base portion at the rear thereof and having a pocket 30 formed therein for receiving the distal (e.g., upstream) end 212 of the shaver. The housing 22 is illustrated as a three-piece construction (as seen best in FIG. 4) including a bottom panel 32 and mateable left and a right side panels 34, 36 wherein the bottom panel and side panels together define an interior space 38 (FIGS. 3A and 3B) of the housing. It is understood, though, that the housing 22 may instead be constructed of more or less than three pieces and/or may have any number of suitable configurations other than the configuration illustrated in FIG. 1 without departing from the scope of the invention.

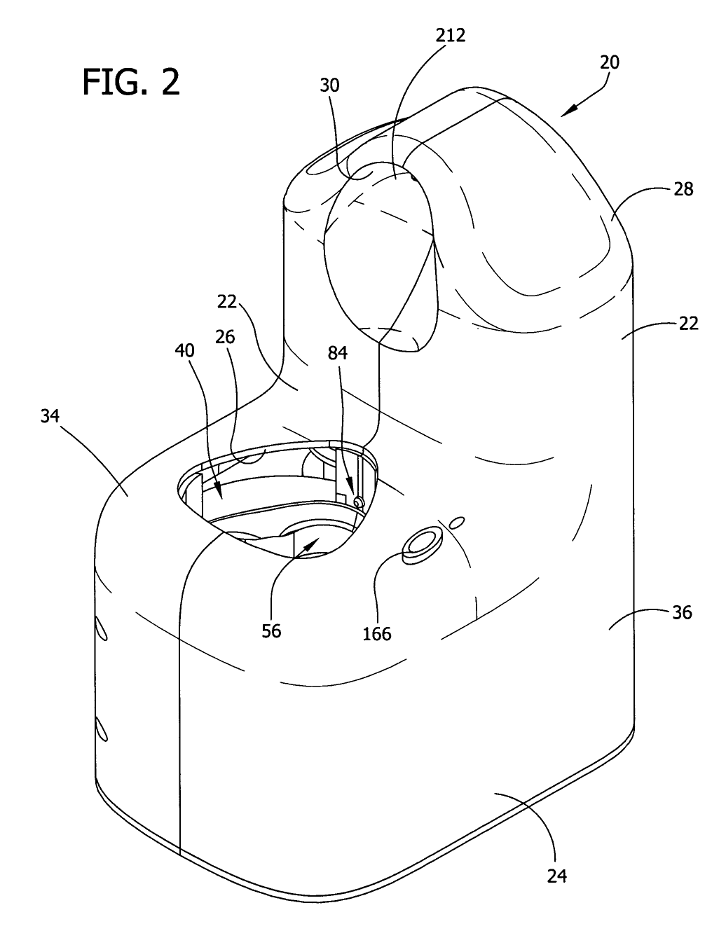

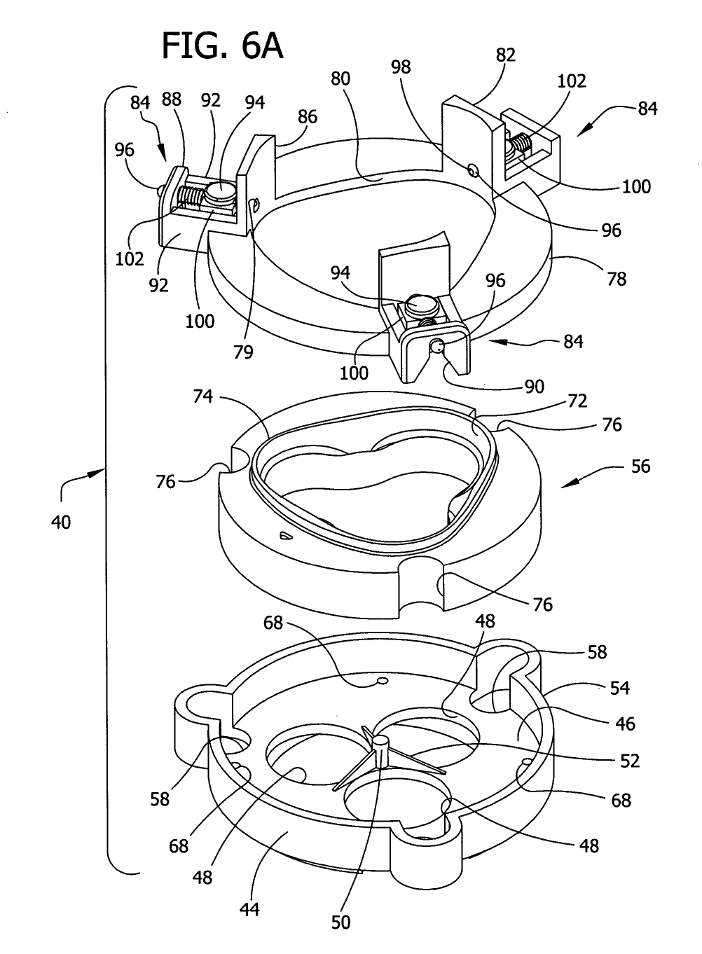

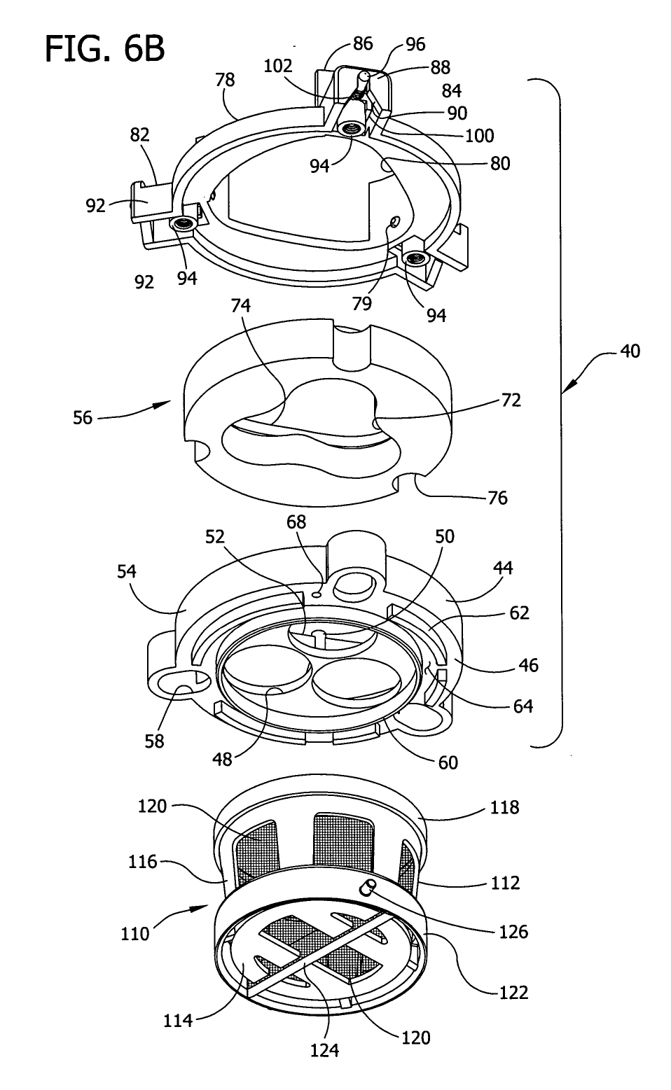

With particular reference to FIGS. 2 and 6A, a shaver support, generally indicated at 40, is disposed within the interior space 38 of the housing 22 generally at and below the opening 26 in the base portion 24 the housing for supporting the shaver 200 during cleaning. The shaver support 40 has a central opening 42 in registry with the opening 26 in the base portion 24 of the housing 22 for receiving the shaver down into the shaver support. The illustrated shaver support 40 comprises a support member 44 having a central plate 46 that includes openings 48 therein corresponding to the number of shaving heads 210 of the shaver 200 (e.g., three openings are shown in the plate of FIG. 6A and correspond to the three shaving heads (e.g., foils) of the rotary shaver shown in FIG. 5). These openings 48 are suitably sized at least as large as the planar (e.g., transverse) dimensions of the shaving heads 210. However, it is contemplated that the openings 48 may be slightly smaller or larger than the planar dimensions of the shaving heads 210 without departing from the scope of this invention.

A stop 50 is formed on the upper surface of the support member central plate 46 for limiting the depth to which the shaver 200 may be inserted into the shaver support 40. The illustrated stop 50 suitably comprises a central post that extends up from the central plate 46 generally at the center thereof or otherwise at a location that corresponds to the portion of the cutting assembly support frame 206 between the shaving heads 210 upon insertion of the shaver 200 into the shaver support 40. Tapered ribs 52 extend transversely out from the central post 50 to provide further support to the shaver 200. The shaver support 40 also has a generally annular side wall 54 extending up from the peripheral edge of the central plate 46 so that the central plate and side wall together broadly define a seat for a sealing member, generally indicated at 56, of the shaver support. The side wall 54 protrudes transversely out from the central plate 46 at three different locations about the periphery thereof to form openings 58, the purpose of which will become apparent.

With reference to FIG. 6B, an annular inner flange 60 depends from the central plate 46 of the support member 44 slightly outward of the shaving head openings 48. A segmented outer flange 62 also depends from the central plate 46 in transversely spaced relationship with the annular inner flange 60 to define an annular gap 64 therebetween. A suitable sealing ring (not shown) seats within the annular gap 64 and seats down against a rim 66 (FIG. 4) of a tubular filter assembly housing 67 (FIG. 4) that is formed integrally with and extends up from the bottom panel 32 of the cleaning system housing 22, with the inner flange 60 of the support member 44 disposed within the filter assembly housing and the outer flange 62 disposed exterior of the filter assembly housing. Openings 68 formed in the central plate 46 align with internally threaded fastener posts 70 formed integrally with the filter assembly housing 67 to allow securement of the shaver support 40 to the filter assembly housing with suitable screw fasteners (not shown). An opening (not shown) is formed in the bottom panel 32 of the cleaning system housing 22 to provide access to the interior of the filter assembly housing 67.

Referring back to FIG. 6A, the sealing member 56 is suitably molded from rubber and has a central, generally triangular opening 72 (e.g., in part defining the shaver support opening 42) to correspond with the general peripheral shape of the cutting assembly 204 of the shaver 200, and more particularly with the general peripheral shape of the sidewall of the cutting assembly support frame 206. The opening 72 is thus suitably sized about equal to the circumference of the cutting assembly support frame 206 so that the sealing member sealingly engages the periphery of the cutting assembly support frame when the shaver 200 is supported by the shaver support 40. A guide member 74 extends up from the sealing member 56 at the opening 72 and tapers slightly outward relative to the peripheral edge of the sealing member opening to guide the shaver 200 into the proper location within the sealing member and down against the support member 44. Three notches 76 are formed in the peripheral edge of the sealing member 56 to leave uncovered the openings in the support member 44.

A cover plate 78 of the shaver support 40 seats down on the side wall of the support member 44 to retain the sealing member 56 in place between the cover plate and the support member and has a central opening 80 (also in part defining the shaver support opening 42) sized slightly larger than the guide member 74 and aligned with the opening 26 in the base portion 24 of the housing 22 for receiving the shaver 200 into the shaver support. In the illustrated embodiment, nozzle assembly mounting brackets 82 are formed integrally with the cover plate 78 at intermittent positions about the periphery of the cover plate for mounting respective nozzle assemblies, generally indicated at 84, on the cover plate. Each mounting bracket comprises an inner wall 86 extending up from the cover plate 78 and having an opening 79 therethrough to allow fluid communication between the nozzle assembly 84 and the shaver 200 as will be described. An outer wall 88 of each nozzle assembly mounting bracket 82 has an inward tapering slot 90 formed therein for use in installing the nozzle assembly 84 into the mounting bracket and retaining the nozzle assembly in place following initial assembly. Side walls 92 of the mounting bracket 82 secure the nozzle assembly 84 against transverse movement.

Each nozzle assembly 84 comprises an internally threaded fitting 94, e.g., a brass fitting, disposed within the nozzle assembly mounting bracket 82 for receiving cleaning gas into the nozzle assembly. A delivery tube 96 extends transverse to the fitting 94 and is connected to the fitting in fluid communication therewith. The delivery tube 96 extends inward from the fitting 94 through the opening 79 in the inner wall 86 of the nozzle assembly mounting bracket 82 and has an exhaust port 98 (broadly, a nozzle assembly exhaust port) in the inner end of the tube to deliver cleaning gas from the nozzle assembly into a respective one of the inlet ports 255 of the shaver 200. A spring seat 100 is mounted over the top of the fitting 94 and provides a seat for one end of a coil spring 102 (broadly, a biasing member) axially mounted on the delivery tube 96, with the opposite end of the spring seating against the outer wall 88 of the nozzle assembly mounting bracket 82. The spring 102 suitably biases the nozzle assembly 84 (and in particular the delivery tube 96) inward of the shaver support 40, e.g. toward the shaver support opening 42.

As illustrated in FIGS. 4 and 6B, a filter assembly, generally indicated at 110, is disposed in the filter assembly housing 67, and is more suitably releasably retained within the filter assembly housing. In the illustrated embodiment of FIG. 6B, the filter assembly 110 is generally cylindrical, or more specifically cup-shaped, and comprises an open frame-structure 112 having a base 114, a sidewall 116 and a rim 118. Mesh screening 120 or other suitable gas permeable material lines the base 114 and sidewall 116 of the filter assembly 110. An annular connecting member 122 extends about and is secured to the sidewall 116 of the filter assembly 110 generally at the base 114 of the frame-structure 112. A cross-bar 124 is integrally formed with and extends across the connecting member 122 for use in gripping the filter assembly 110 to remove and install the filter assembly in the filter assembly housing 67.

A pair of pins 126 (one is shown in FIG. 6B) extend radially outward of the connecting member 122 and are sized for seating within respective grooves (not shown) formed in the inner surface of the filter assembly housing 67 upon rotation of the assembly relative to and within the filter assembly housing to releasably secure the filter assembly therein. In its installed position, the rim 118 of the filter assembly 110 sealingly engages the sealing ring disposed in the gap 64 between the flanges 60 and 62 depending from the central plate 46 of the shaver support member 44 beneath the openings 48 formed in the central plate. It is understood that the filter assembly 110 may be configured other than as illustrated in FIG. 6B, as long as it is configured and positioned within or otherwise releasably mounted on the cleaning system housing 22 to receive hair clippings directed out of the shaver 200 via the shaving heads 210 as will be described. It is also understood that the frame-structure 112 of the filter assembly 110 may be omitted, e.g., whereby the filter assembly comprises a bag-shaped filter material, without departing from the scope of this invention.

With reference now to FIGS. 3A, 3B and 4, also disposed within the interior space 38 of the housing 22 is a pressure vessel (indicated generally at 130) for containing pressurized cleaning gas, a pressurized gas generating device (indicated generally at 132) for charging the pressure vessel with pressurized cleaning gas, and a gas delivery assembly (indicated generally at 134) for delivering cleaning gas from the pressure vessel into the shaver 200. The term gas as used herein is intended to include gas and any other substance in a gaseous or otherwise aeriform state such as vapor, steam and the like. In one suitable embodiment, the cleaning gas used to clean hair clippings from the shaver 200 suitably comprises air or a mixture thereof. It is contemplated, however, that a gas or gas mixture such as a sterilizing gas or other suitable gas useful for cleaning or otherwise treating metal, ceramic and/or plastic components may be used without departing from the scope of this invention.

The pressurized gas generating device 132 of the illustrated embodiment suitably comprises a compressor, e.g., comprised of a compressor pump 136 and motor 138 for driving the pump. However, other pumps and/or devices suitable for generating a pressurized gas in situ (e.g., mounted on or disposed within the cleaning system housing) may be used and remain within the scope of this invention. The pressure vessel 130 of the illustrated embodiment is in the form of a gas cylinder or canister oriented in a generally upright orientation with the inlet/exhaust end 140 of the gas cylinder facing downward. A support stand 141 is disposed within the housing 22 and mounted on the bottom panel 32 thereof to support the gas cylinder in its upright orientation. The inlet/exhaust end 140 of the gas cylinder extends down through the support stand 141 so that the inlet/exhaust opening of the gas cylinder is disposed below the stand.

While the pressure vessel 130 is illustrated as being in a generally vertical orientation, it is understood that the pressure vessel may be horizontal or oriented at substantially any angle, and/or that the inlet/exhaust opening may be other than at the bottom of the pressure vessel without departing from the scope of this invention. It is also contemplated that the pressure vessel 130 may be configured other than as a cylinder as long as it is capable of containing pressurized contents. Moreover, the pressure vessel 130 may be held or otherwise supported by or in the housing 22 other than by the support stand 141, such as by suitable brackets (not shown) or other suitable structure. It is further contemplated that the pressure vessel 130 may be supported by or otherwise mounted on the exterior of the cleaning system housing 22.

In one embodiment the compressor (broadly, the pressurized gas generating device 132) is suitably operable to pressurize cleaning gas within the pressure vessel 130 to a predetermined operating pressure in the range of about 125 psi to about 175 psi. The compressor may also suitably pressurize the cleaning gas within the pressure vessel 130 to the predetermined operating pressure within about 30 to about 60 seconds of compressor operating time. The pressure vessel 130 (e.g., the gas cylinder in the illustrated embodiment) is suitably sized to have a volume in the range of at least about 150 cubic centimeters (cc), and more suitably in the range of about 100 cc to about 200 cc. However, the volumetric capacity of the pressure vessel 130 may vary within the scope of this invention depending on the desired cleaning duration and number of cleanings to be conducted following filling of the pressure vessel. For example, the pressure vessel 130 of the illustrated embodiment is intended to be charged with pressurized cleaning gas and then completely exhausted once for each cleaning of the shaver 200. However, the pressure vessel 130 may be sized to permit more than one cleaning of the shaver 200 before needing to be recharged by the pressurized gas generating device 132.

A suitable conduit 142 (indicated in FIG. 4 in dashed lines), such as flexible tubing, leads from the compressor to a T-connector 143 to which a pressure sensor 144 is connected upstream from the pressure vessel 130 (i.e., intermediate the compressor and pressure vessel). The terms upstream and downstream are used herein relative to the direction in which cleaning gas flows throughout the cleaning system 20 and shaver 200, with the downstream direction referring to flow in a direction away from the pressurized gas generating device 132. An additional conduit 146 extends downstream from the T-connector 143 to another T-connector 148 (FIG. 4). The T-connector 148 is also connected to the inlet/exhaust opening of the pressure vessel 130.

With continued reference to FIG. 4, a suitable conduit 150 extends downstream from the T-connector 148 and is connected at its other end to the inlet of a suitable valve 152. In a particularly suitable embodiment, the valve 152 is a solenoid valve. For example, the solenoid valve 152 may be operable between a closed position that blocks the flow of cleaning gas therethrough and an open position upon operation thereof to permit the flow of cleaning gas to the shaver 200. It is understood, however, that other suitable valves may be used to control the flow of cleaning gas to the shaver 200 without departing from the scope of this invention. Another conduit 160 leads from an outlet of the valve 152 downstream to a manifold 154. The manifold 154 comprises a single inlet 156 and multiple outlets 158, such as one outlet for each nozzle assembly 84 (e.g., the manifold of the illustrated embodiment has three outlets corresponding to the three nozzle assemblies). Suitable conduits 162 extend respectively from the manifold outlets 158 to the corresponding nozzle assembly fittings 94.

Alternatively, the manifold 154 may comprise a tube (not shown) sized and configured for encircling part or all of the shaver when the shaver is supported by the shaver support. While not shown in the drawings, it is contemplated that such a tube has a continuous inner channel and that the nozzles assemblies 84 are connected directly to the manifold 154 in fluid communication with the continuous inner channel such that cleaning gas received by the manifold is delivered throughout the entire channel for flow directly to each of the nozzle assemblies.

The valve 152, manifold 154, nozzle assemblies 84 and related conduits 150, 160 and 162 together thus broadly define the gas delivery assembly 134 for delivering cleaning gas to the shaver 200, and more particularly to the hair pocket 208 of the shaver. The pressurized gas generating device 132 and pressure vessel 130 together broadly define a source of cleaning gas, the gas delivery assembly 134 thus delivering cleaning gas from the source of cleaning gas to the hair pocket 208 of the shaver 200. It is understood that the pressure vessel 130 may be omitted from the cleaning system 20, such that the source of cleaning gas comprises only the pressurized gas generator 132 (e.g., the compressor) and delivers cleaning gas directly to the delivery assembly 134 upon operation of the cleaning system without departing from the scope of this invention.

A suitable microprocessor control 164 is also disposed in the housing 22 to control operation of the cleaning system 20. The control 164 is electrically connected to a remote source (not shown) of electrical current via suitable wiring (not shown) and power cord (not shown). Alternatively, the source of electrical current may comprise one or more batteries (not shown). A start button 166 (e.g., a conventional push button arrangement) is accessible on the cleaning system housing 22 and is electrically connected to the control 164 for initiating operation of the cleaning system. The compressor motor and the solenoid valve 152 are also electrically connected to the control 164.

As best seen in FIGS. 3A and 3B, a contact assembly 168 comprises a support arm 170 pivotally mounted in the upstanding portion 28 of the shaver housing 22, generally at the pocket 30 formed therein. Electrically conductive contact pins 172 are held in assembly with the outer end of the arm 170 and extend outward of the housing 22 generally into the pocket 30 formed in the upstanding portion 28 of the housing. Coil springs 174 are operatively connected to the support arm 170 to pivotally bias the arm in a direction in which the contact pins 172 are urged generally outward and downward relative to the upstanding portion 28 of the housing 22. The contact pins 172 are positioned for electrically conductive contact with corresponding pins (not shown) disposed at the distal (e.g., upstream) end 212 of the shaver 200 upon insertion of the shaver into the cleaning system 20. The contact pins 172 are electrically connected to the control 164 by suitable wiring (not shown).

In operation, a shaver to be cleaned, such as the rotary shaver 200 illustrated in FIG. 5, is inserted, cutting assembly 204 (e.g., the downstream end of the illustrated embodiment) first, through the base portion opening 26 and shaver support opening 42 down into the shaver support 40 until the cutting assembly of the shaver seats down against the stop 50 of the support member 44. In this position, the shaving heads 210 are aligned with the openings 48 in the central plate 46 and the sealing member 56 sealingly engages the periphery of the side wall of the cutting assembly support frame 206. As the shaver 200 is inserted down into the shaver support 40, the outward taper of the support frame 206 side wall contacts the outlet ends of the nozzle assemblies 84 and urges the nozzle assemblies outward relative to the shaver and shaver support against the bias of the nozzle assembly springs 102.

As the shaver 200 is inserted further down to the stop 50 of the shaver support member 44, the outlet ends of the nozzle assemblies 84 come into alignment with the inlet ports 255 of the shaver. In this position, the nozzle assembly springs 102 urge the nozzle assemblies 84 back inward toward the shaver support opening 42 so that the exhaust ports 98 of the nozzle assemblies are aligned with and adjacent to or even slightly disposed within the inlet ports 255 of the shaver 200 to provide fluid communication between the hair pocket 210 of the shaver and the gas delivery assembly 134 of the cleaning system 20. As an example, in the inserted position of the shaver 200, the exhaust ports 98 of the nozzle assemblies 84 are suitably within at least about 0.25 inches, more suitably about 0.1 inches of the inlet ports 255 of the shaver, still more suitably within at least about 0.05 inches of the inlet ports, and most suitably the exhaust ports 98 are flush with or even slightly within the inlet ports of the shaver.

While the nozzle assemblies 84 of the illustrated embodiment are urged outward relative to the shaver 200 by the outward taper of the cutting assembly support frame 206 upon insertion of the shaver into the shaver support 40, it is understood that other shaver configurations may be used to effect such outward urging of the nozzle assemblies. For example, it is contemplated that an annular ridge (not shown) may encircle each of the inlet ports 255 of the shaver 200 such that the annular ridge urges the nozzle assembly 84 outward relative to the shaver upon insertion of the shaver into the shaver support. As the shaver 200 is urged further down into the shaver support 40, the inlet ports 255 of the shaver come into alignment with the exhaust ports 98 of the nozzle assemblies 84. It is also contemplated that the nozzle assemblies 84 need not be urged outward at all upon insertion of the shaver 200 into the shaver support 40 and remain within the scope of this invention, as long as the inlet ports 255 align with the respective exhaust ports 98 of the nozzle assemblies upon full insertion of the shaver into the shaver support.

With the shaver 200 seated in the shaver support 40, the shaver is leaned back toward the upstanding portion 28 of the housing 22, urging the distal end 212 (e.g., the upstream end) of the shaver into the pocket 30 formed in the housing. The distal end 212 of the shaver 200 contacts the contact pins 172 mounted on the pivotable support arm 170. The contour of the distal end 212 of the shaver 200 urges the arm 170 to pivot against the bias of the spring 174 until the contact pins 172 are aligned with the opening (not shown) in the end of the shaver. The spring 174 urges the arm 170 to pivot back toward its initial position to urge the contact pins 172 into the opening in the distal end 212 of the shaver for electrical contact with the corresponding pins in the shaver to electrically connect the shaver to the cleaning system 20.

The valve 152 is suitably initially in its closed configuration (e.g., prior to a cleaning operation) to inhibit cleaning gas from flowing downstream of the valve to the manifold 154 and nozzle assemblies 84. To clean hair clippings from the shaver 200, the start button 166 is depressed to signal the control 164, following which the control electrically operates the compressor to charge the pressure vessel 130 via the conduits 142, 146 between the compressor and pressure vessel. Cleaning gas also flows downstream of the pressure vessel via conduit 150 to the closed valve. The control 164 operates the compressor for a predetermined time period intended to pressurize the gas in the vessel 130 to a predetermined pressure, or within a predetermined pressure range. The pressure sensor 144 monitors the gas pressure in the vessel 130 and in the event that the pressure exceeds a predetermined maximum pressure, gas is bled from the system 20 (such as through a conventional pressure release valve (not shown)) to inhibit over pressurization.

Once the compressor operation cycle is completed, the compressor is deactivated and the control 164 sends a signal to the valve 152 to energize the valve to configure the valve in its open configuration. Pressurized cleaning gas stored in the pressure vessel 132 flows rapidly from the pressure vessel through the conduits 150, 160 and valve 152 to the manifold 154. The cleaning gas subsequently flows from the manifold 154 to the nozzle assemblies 84 and is delivered through the exhaust ports 98 of the nozzle assemblies and corresponding inlet ports 255 of the shaver 200 into the hair pocket 208 of the shaver. In particular, in the illustrated embodiment the cleaning gas is delivered into the hair pocket 208 of the shaver 200 upstream of the cutting blades and shaving heads 210. The cleaning gas flows out of the shaver 200 through the openings in the shaving heads 210 and through the indentations 213 formed in the guard rings 211 surrounding the shaving heads, passing over the cutting blades on the way. Hair clippings accumulated in the hair pocket 208 and on the shaving heads 210 become entrained in the gas stream and are carried out of the shaver 200 with the cleaning gas, thereby leaving a cleaned out hair pocket and clean cutting blades and shaving heads. Because the hair pocket is otherwise sealed, hair clippings are inhibiting against becoming trapped or stuck in small cracks or other openings through which gas would be exhausted if not for sealing the hair pocket.

The flow of cleaning gas carries the entrained hair clippings exiting the shaving heads 210 down into the filter assembly 110. Cleaning gas continues through the filter assembly 110 and is exhausted from the cleaning system 20 via the exhaust opening in the bottom panel 32 of the housing 22. Hair clippings are trapped in the filter assembly 110 and retained therein until the filter assembly is removed from the cleaning system 20 and either cleaned or replaced.

In one embodiment, the shaver 200 is activated during the cleaning operation. In this way, the cutting blades are moved in their normal manner as the cleaning gas flows from the inlet ports 255 through the hair pocket 208 and out the shaving heads 210. However, it is understood that operating the shaver 200 during the cleaning cycle is not required. The shaver 200 is shut off by the system 20 once the cleaning cycle is complete.

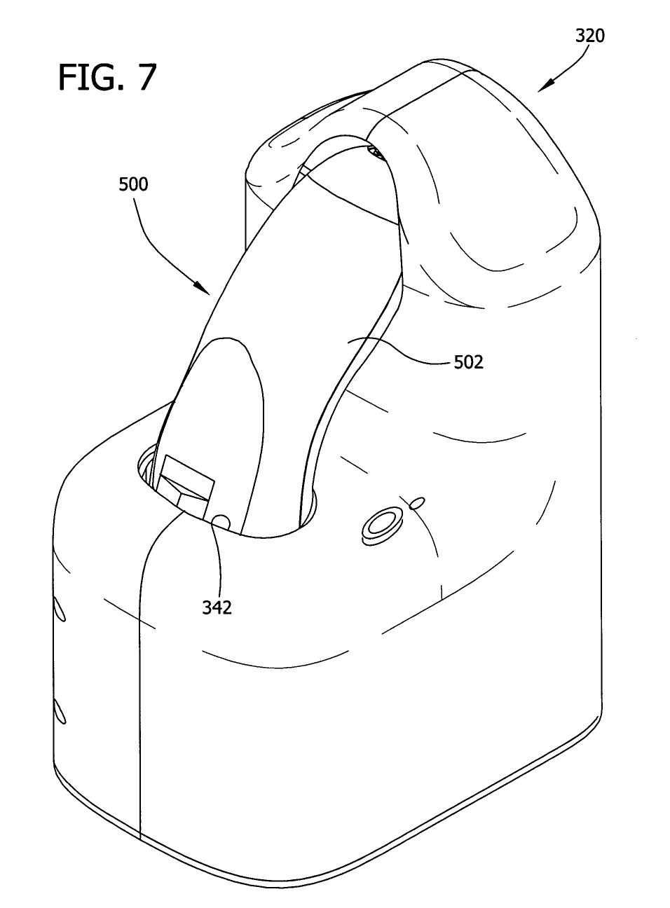

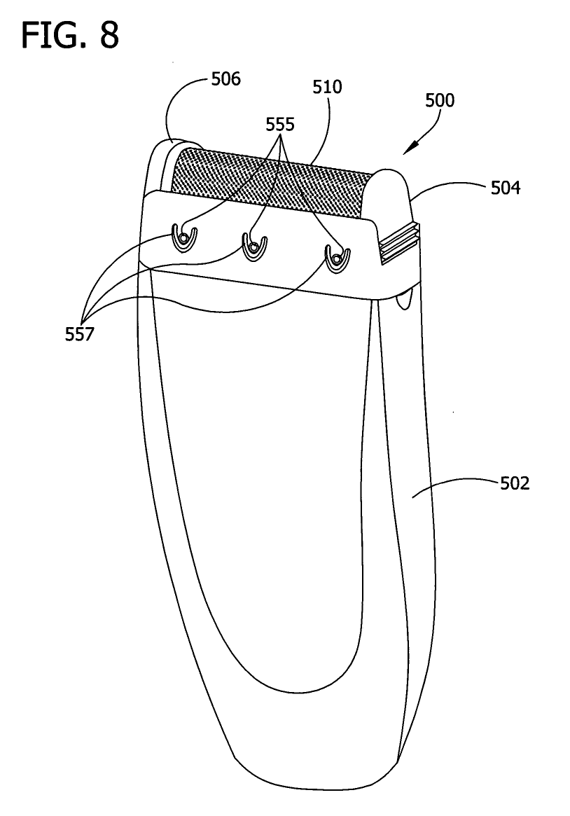

FIGS. 7 and 8 illustrate an alternative embodiment of a cleaning system 320 and shaver 500. The shaver 500 of this embodiment is suitably a foil shaver similar to conventional foil shavers in that it has a handle portion 502, a cutting assembly 504 releasably connected to the handle portion, and an interior hair pocket (not shown) defined by the cutting assembly and handle portion. The cutting assembly comprises a support frame 506 and an apertured foil 510 (broadly, an outer cutting member) supported by the frame. A cutting blade (not shown) (broadly, an inner cutting member) is disposed within the hair pocket in driving connection with the gear drive and motor of the shaver 500 and abutting against the foil 510 for reciprocating, sliding movement relative to the foil to cut hair that extends through the apertures in the foil.

The shaver 500 has a set of three inlet ports 555 and corresponding guide members 557 on the rear of the cutting assembly 504, similar to the inlet ports 255 and guide members 257 of the rotary shaver of FIG. 5. Alternatively, or additionally, inlet ports and corresponding guide members may be disposed in the front of the shaver 500 and/or on the laterally opposite sides of the shaver.

The cleaning system 320 of this alternative embodiment is constructed and operates substantially the same as the cleaning system 20 with the exception that the shaver support opening 342 is configured in accordance with the more rectangular-shaped periphery of the foil shaver cutting assembly 504.

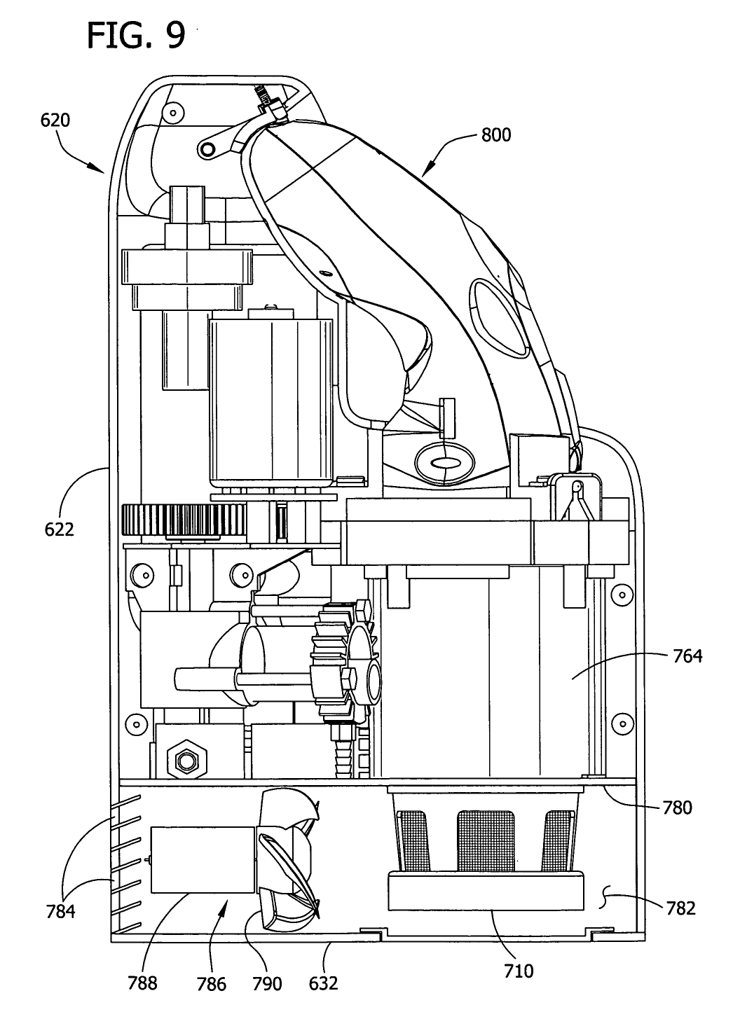

In another alternative embodiment, illustrated in FIG. 9, the shaver 800 is a rotary shaver substantially identical to the rotary shaver 200 of FIG. 5. The cleaning system 620 comprises substantially all of the same operating components as the cleaning system 20 of FIGS. 1-6, with the addition of a sealing panel 780 disposed within the housing 622 in spaced relationship above the bottom panel 632 to define a vacuum chamber 782. The filter assembly 710 extends down into the vacuum chamber 782 to provide fluid communication between the vacuum chamber and the filter assembly (and hence the hair pocket of the shaver 800).

The vacuum chamber 782 is vented by suitable vent openings 784 formed in the housing 622. A fan unit 786 (broadly, a vacuum generating device) comprising a suitable motor 788 and fan blade assembly 790 is disposed in the vacuum chamber 782. In operation, the fan unit 786 is operated by the control 764 while the valve (not shown but substantially the same as the valve 152 of FIG. 4) is open. In this manner, negative air pressure is produced in vacuum chamber 782, assisting in providing a low-pressure zone in the vacuum chamber for more rapidly drawing the pressurized air in the hair pocket of shaver 800 into filter assembly 34 for subsequent exhaustion from the housing 622 via vent openings 784.

When introducing elements of the present invention or preferred embodiments thereof, the articles “a”, “an”, “the”, and “said” are intended to mean that there are one or more of the elements. The terms “comprising”, “including”, and “having” are intended to be inclusive and mean that there may be additional elements other than the listed elements.

As various changes could be made in the above constructions and methods without departing from the scope of the invention, it is intended that all matter contained in the above description and shown in the accompanying drawings shall be interpreted as illustrative and not in a limiting sense.

What is claimed is:

1. A cleaning system for cleaning hair clippings from an electric shaver, said electric shaver having an interior space in which hair clippings accumulate during operation, said cleaning system comprising:
a housing having a shaver support for supporting the electric shaver during operation of the cleaning system; and
a gas delivery assembly comprising at least one nozzle assembly configured and arranged for directing cleaning gas to flow into the interior space of the shaver.

2. The cleaning system set forth in claim 1 further comprising a source of cleaning gas supported by the housing, the at least one nozzle assembly being in fluid communication with said source of cleaning gas to receive cleaning gas from said source and directing said cleaning gas to flow into the interior space of the shaver.

3. The cleaning system set forth in claim 2 wherein the source of cleaning gas comprises a pressure vessel configured for containing pressurized cleaning gas therein.

4. The cleaning system set forth in claim 3 wherein the source of cleaning gas further comprises a pressurized gas generating device operable to charge the pressurize vessel with pressurized cleaning gas.

5. The cleaning system set forth in claim 2 wherein the source of cleaning gas comprises a pressurized gas generating device operable to deliver cleaning gas to the at least one nozzle assembly.

6. The cleaning system set forth in claim 4 wherein the pressurized gas generating device comprises a compressor.

7. The cleaning system set forth in claim 2 wherein the gas delivery assembly further comprises a valve operable between a closed position in which the valve blocks the flow of cleaning gas from the source of cleaning gas to the at least one nozzle assembly, and an open position in which cleaning gas is allowed to flow from the source of cleaning gas through the valve to the nozzle assembly for delivery into the interior space of the shaver.

8. The cleaning system set forth in claim 1 wherein the shaver is of the type comprising at least one outer cutting member for contact with a user's skin and having openings therein for receiving hairs therethrough, and at least one inner cutting member disposed within the interior space of the shaver and movable relative to the outer cutting member to cut hairs received through the outer cutting member, the nozzle assembly of the cleaning system being configured and arranged to direct cleaning gas into the interior space of the electric shaver other than through the openings in the at least one outer cutting member.

9. The cleaning system set forth in claim 1 wherein the cleaning gas is air.

10. The cleaning system set forth in claim 1 further comprising a filter assembly for collecting hair clippings exhausted from the shaver during operation of the cleaning system.

11. The cleaning system set forth in claim 2 wherein the gas delivery assembly comprises at least two of said nozzle assemblies, said gas delivery assembly further comprising a manifold in fluid communication with the source of cleaning gas for receiving cleaning gas from said source into said manifold, the nozzle assemblies being in fluid communication with the manifold for receiving cleaning gas from the manifold for delivery into the interior space of the shaver.

12. The cleaning system set forth in claim 1 wherein the at least one nozzle assembly is moveable relative to the shaver support.

13. The cleaning system set forth in claim 12 wherein the shaver support has an opening for receiving the shaver into said support, the at least one nozzle assembly having an exhaust port one of adjacent to and disposed within the shaver support opening, the at least one nozzle assembly being moveable relative to the shaver support toward and away from the shaver support opening.

14. The cleaning system set forth in claim 13 wherein the nozzle assembly further comprises a biasing member biasing the nozzle assembly toward the shaver support opening.

15. The cleaning system set forth in claim 7 wherein the valve is a solenoid valve.

16. The cleaning system set forth in claim 1 further comprising a vacuum generating device operable to draw cleaning gas out from the interior space of the shaver.

17. A combination electric shaver and cleaning system for cleaning hair clippings from the electric shaver, said electric shaver comprising
an outer cutting member for contact with a user's skin and having openings therein for receiving hairs therethrough, the outer cutting member at least in part defining an interior space of the shaver in which hair clippings accumulate,
and an inner cutting member within the interior space of the shaver and moveable relative to the outer cutting member to cut hairs received through the outer cutting member, the shaver having at least one inlet port other than the openings in said outer cutting member and in fluid communication with the interior space of the shaver for receiving cleaning gas into said interior space,
said cleaning system comprising a housing having a shaver support for supporting the electric shaver during operation of the cleaning system; and
a gas delivery assembly comprising at least one nozzle assembly configured and arranged for directing cleaning gas directly into the at least one inlet port of the electric shaver for delivery of the cleaning gas into the interior space of the shaver.

18. The combination set forth in claim 17 wherein the outer cutting member of the shaver defines a downstream end of the shaver through which cleaning gas received into the interior space of the shaver is subsequently exhausted along with the hair clippings, the inner cutting member of the shaver being upstream of the outer cutting member, the at least one inlet port being disposed upstream of the outer cutting member such that cleaning gas enters the interior space of the shaver at said at least one inlet port and flows downstream to the outer cutting member for exhaustion from the shaver.

19. The combination set forth in claim 18 wherein the at least one inlet port is disposed upstream of the inner cutting member such that cleaning gas enters the interior space of the shaver at said at least one inlet port upstream of the inner cutting member and flows downstream over the inner cutting member to the outer cutting member for exhaustion from the shaver.

20. The combination set forth in claim 17 wherein the shaver comprises a rotary shaver.

21. The combination set forth in claim 17 wherein the shaver comprises a foil shaver.

22. The combination set forth in claim 17 wherein the cleaning system further comprises a source of cleaning gas supported by the housing, the at least one nozzle assembly being in fluid communication with said source of cleaning gas to receive cleaning gas from said source for directing said cleaning gas into the interior space of the electric shaver.

23. The combination set forth in claim 22 wherein the source of cleaning gas comprises a pressure vessel configured for retaining pressurized cleaning gas therein.

24. The combination set forth in claim 23 wherein the source of cleaning gas further comprises a pressurized gas generating device for charging the pressure vessel with pressurized cleaning gas.

25. The combination set forth in claim 22 wherein the gas delivery assembly further comprises a valve intermediate the source of cleaning gas and the at least one nozzle assembly, said valve being operable between a closed position in which the valve blocks the flow of cleaning gas from the source of cleaning gas to the at least one nozzle assembly, and an open position in which cleaning gas is allowed to flow from the source of cleaning gas to the nozzle assembly for delivery into the interior space of the shaver.

26. The combination set forth in claim 17 wherein the cleaning gas is air.

27. The combination set forth in claim 17 wherein the at least one nozzle assembly has an exhaust port through which cleaning gas is delivered directly into the corresponding at least one inlet port of the shaver, said exhaust port being within at least about 0.25 inches of the at least one inlet port of the shaver upon insertion of the shaver in the shaver support.

28. The combination set forth in claim 27 wherein the exhaust port of the at least one nozzle assembly is within at least about 0.1 inches of the at least one inlet port of the shaver upon insertion of the shaver in the shaver support.

29. A method for cleaning hair clippings from an electric shaver having an outer cutting member, and interior space in which hair clippings accumulate during use, said outer cutting member at least in part defining said interior space and having openings therein for receiving hair into the interior space of the shaver for cutting, said method comprising:
charging a pressure vessel with pressurized cleaning gas;
releasing said cleaning gas from the pressure vessel;
delivering the cleaning gas released from the pressure vessel into the interior space of the shaver other than through the openings in the outer cutting member whereby hair clippings in the interior space become entrained in the flow of cleaning gas, and
exhausting the cleaning gas and entrained hair clippings from the interior space of the shaver through the openings in the outer cutting member of the shaver.
